(19) United States
(12) Patent Application Publication
(10) Pub. No.: US 2014/0324584 A1
(43) Pub. Date: Oct. 30, 2014

(54) ADVERTISEMENT METHOD USING A TELEPHONE SYSTEM

(71) Applicant: WILFRED NELSON, Detroit, MI (US)

(72) Inventor: WILFRED NELSON, Detroit, MI (US)

(21) Appl. No.: 13/872,039

(22) Filed: Apr. 26, 2013

(51) Int. Cl. G06Q 30/02; H04W 4/12

(52) U.S. Cl. CPC G06Q 30/0257; H04W 4/12
USPC 705/14.55

(57) ABSTRACT

An advertisement method using a telephone system including the steps of: initiating a call via a telephone; transmitting to telephone advertisements instead of placing the caller on hold to hear silence or ring back tones, before permitting voice mail instructions, and before permitting checking of voice mail; choosing an advertisement which appeals to the caller by pressing a key on the telephone; and transmitting to the telephone a confirmation text message to permit the caller to redeem a discount relating to the advertisement chosen by the caller. The method can use a mobile telephone system including the steps of: sending the initiated call to a cell tower; relaying the call to a service provider; checking a mobile identification number of the caller's telephone; and relaying the call to a computer server which attaches the advertisements for transmission to the caller's telephone.

### CROSS-REFERENCE TO RELATED APPLICATIONS

The present patent application claims priority from and is a continuation-in-part of U.S. Provisional Patent Application 61/689,328 filed on Jun. 4, 2012.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates generally to an advertisement method using a telephone system.

More particularly, the present invention relates to an advertisement method using a mobile telephone system, including the steps of: sending an initiated telephone call to a cell tower; relaying the initiated telephone call to a service provider; and relaying the telephone call to a computer server which attaches one or more advertisements for transmission to the caller's telephone device.

The prior, but not necessarily relevant, art is exemplified by:
Chavez, Jr. et al. U.S. Pat. No. 6,603,844;
Strietzel U.S. Pat. No. 7,489,768;
Colson et al. U.S. Pat. No. 7,844,485;
Zhang et al. U.S. Pat. No. 7,921,034;
Ramer et al. U.S. Pat. No. 8,103,545;
Ho et al. U.S. Pat. No. 8,135,613;
Oh US Patent Application Publication U.S. 2006/0109969;
Radziewicz et al. US Patent Application Publication U.S. 2006/0285675;
Vitenson et al. US Patent Application Publication U.S. 2007/0116227;
David et al. .S Patent Application Publication U.S. 2009/0191852; and
Stifelman et al. US Patent Application Publication U.S. 2010/0027776.

It is a desideratum of the present invention to avoid the animadversions of conventional and present methods, and at the same time to provide a very convenient and easy to use method as described herein.

### SUMMARY OF THE INVENTION

The present invention provides an advertisement method using a telephone system, comprising the steps of: initiating a telephone call via a telephone device; transmitting to the caller's telephone device one or more advertisements in lieu of placing the caller on hold to hear silence, in lieu of telephone ring back tones, before permitting voice mail instructions, and before permitting checking of voice mail; choosing an advertisement which appeals to the caller by pressing a first predetermined key on the caller's telephone device; and transmitting to the caller's telephone device a confirmation text message to permit the caller to redeem a discount relating to the advertisement chosen by the caller.

The present invention also provides an advertisement method as described hereinabove using a mobile telephone system, including the steps of: sending the initiated telephone call to a cell tower; relaying the initiated telephone call to a service provider; checking a mobile identification number of the caller's telephone device; and relaying the telephone call to a computer server which attaches one or more advertisements for transmission to the caller's telephone device.

An object of the invention is to provide a target audience based on knowledge and information of the owner of a mobile communication device or other telephone device stored by the service provider.

Another object of the invention is to provide an advertisement method which includes the step of pressing a second predetermined key on the caller's telephone device to enable the caller to listen to continuous advertisements.

A further object is to generate an alternate source of revenue for the service provider from advertising.

Another object is to provide an advertisement method which includes the step of stopping an advertisement being listened to by the caller immediately if the intended party being called answer the initiated telephone call before the advertisement being listened to by the caller is completed.

A further object is to provide such an advertisement method which includes the step of, upon pressing the second predetermined key on the caller's telephone device to enable the caller to listen to continuous advertisements, connecting an automated voice prompter to the caller's telephone device to guide the caller though available advertisement categories which can be selected by the caller pressing an associated key on the caller's telephone device.

Another object is to provide such an advertisement method which includes the step of pressing a third predetermined key on the caller's telephone device to repeat an advertisement completely.

A further object is to provide such an advertisement method which includes the step of remaining on the line after the call is completed to enable the caller to hear the remainder of the stopped advertisement.

Yet another object of the invention is to provide such an advertisement method which includes the step of transmitting to the caller's telephone device a message stating “Please enjoy the message while your party is being reached.”

Other objects, advantages, and features of the present invention will become apparent to those persons skilled in this particular area of technology and to other persons after having been exposed to the present patent application when read in conjunction with the accompanying patent drawings.

### BRIEF DESCRIPTION OF THE DRAWINGS

FIG. 1 is a front view of an advertisement receiving mobile telephone unit in accordance with the present invention.

FIG. 2 is a side view of the FIG. 1 unit in accordance with the present invention.

FIG. 3 is a top view of the FIG. 1 unit of the invention.

FIG. 4 is a bottom view of the FIG. 1 unit of the invention.

FIG. 5 is a diagram illustrating the advertisement receiving mobile telephone system in accordance with the present invention.

### DETAILED DESCRIPTION OF THE INVENTION

The present invention provides an advertisement method using a telephone system, comprising the steps of initiating a telephone call via a telephone device; transmitting to the caller's telephone device one or more advertisements in lieu of placing the caller on hold to hear silence, in lieu of telephone ring back tones, before permitting voice mail instructions, and before permitting checking of voice mail; choosing an advertisement which appeals to the caller by pressing a first predetermined key on the caller's telephone device; and transmitting to the caller's telephone device a confirmation text message to permit the caller to redeem a discount relating to the advertisement chosen by the caller.

The present invention also provides an advertisement method as described hereinabove using a mobile telephone system, including the steps of sending said initiated telephone call to a cell tower; relaying said initiated telephone call to a service provider; checking a mobile identification number of the caller's telephone device; and relaying the telephone call to a computer server which attaches said one or more advertisements for transmission to the caller's telephone device.

The present invention provides mobile phone and cellular phone advertising.

In particular, the invention provides a system and method for generating revenue from classified advertisements using mobile and cellular phones by replacing the phone ring back tone with one or more advertisements.

The invention provides a system and method for generating revenue from advertisements over current and future generation wireless networks to portable electronic devices.

In particular, the telephone ringing in the caller's ear is replaced with an informative advertisement, targeted to the telephone caller making the call.

One purpose of the invention is to create an alternate source of revenue for the wireless service provider and for the marketers, distributors, and publishers of classified advertising.

The present invention provides a method for captive classified advertising using a mobile communication device, by replacing the normal ring back tone with an informative advertisement.

The method includes creating a new revenue stream while reducing advertising costs. The method includes the steps of targeting advertising, delaying the phone ring back tone, and placing the recorded advertisement to the captive audience listener.

The method is includes a content database server which can include owner, marketer, publisher or distributor of classified information, binary multi-media into a database.

The present invention relates generally to a system and method for delaying an incoming telephone call for a predetermined period of time to allow the “caller” to hear an advertisement instead of a ring tone, thereby generating a source of revenue for the service provider of service for providing a captive audience for an audio advertisement.

With the wide spread adoption of third generation (30) mobile phone technologies, wireless telephone and implementation of fourth generation (4G) mobile phone technologies, wireless telephone networks are now capable of supporting the transmission of larger amounts of communication devices, to a captive audience with no other choice but to hear the advertisement while their parties are being reached

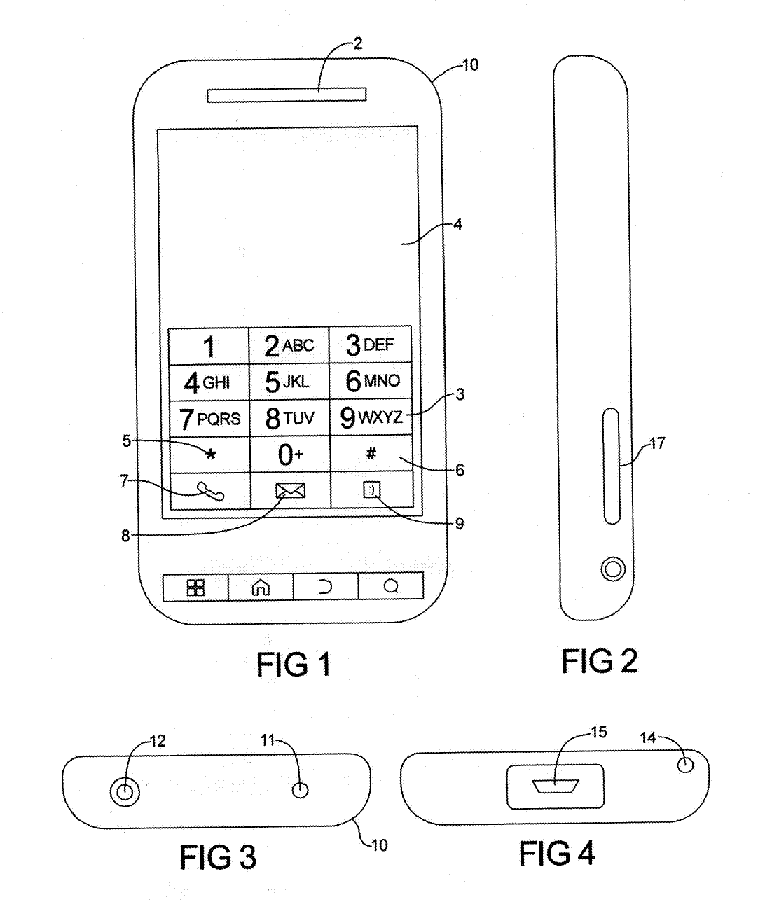

With reference to FIGS. 1-4, there is shown an advertisement receiving mobile telephone unit 10 in accordance with the present invention.

The unit 10 includes a speaker 2, a dial pad 3, a display screen 4, a star (*) button 5, a pound (#) key 6, a send key 7, a message view key 8, a mistake key 9, a power button 11, a bluetooth plug-in 12, and a media volume key 17.

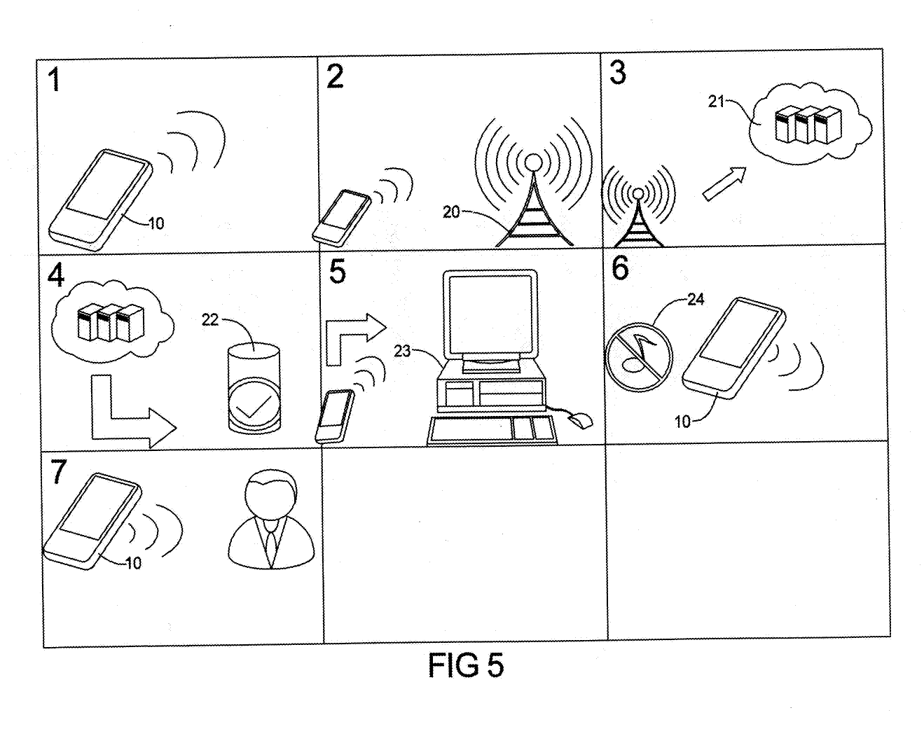

A call is placed when the user of the unit 10 actuates the send key 7. This is illustrated by box 1 in FIG. 5.

The call is transmitted to a cell phone tower 20. This is illustrated in box 2 of FIG. 5. The cell phone tower 20 then relays the call signal to the service provider 21. This is illustrated in box 3 of FIG. 5.

The service provider 21 verifies the time of the call and the telephone bill status. The service provider 21 also checks the Mobile Identification Number (MIN) 22. This is illustrated in box 4 of FIG. 5.

The call is then delayed through a computer server 23 which attaches the advertisement 24. This is illustrated in box 5 of FIG. 5.

The advertisement 24 is then sent to the caller instead of a ring back tone. This is illustrated in box 6 of FIG. 5.

After a predetermined period of time, the telephone call is then forwarded to the intended person. This is illustrated in box 7 of FIG. 5.

If the caller likes the advertisement, the caller would press the pound key 7 shown in FIG. 1. A text message with a bar code is then to the unit 10 to receive a discount relating to the advertisement the caller just heard. from the service provider 21.

If the intended called party answers the call before the advertisement is completed, the advertisement stops. If the caller wishes to hear the remainder of the advertisement, the caller would remain on the phone, or the caller would press the star key 5 to repeat the entire advertisement.

If the caller wishes to browse the advertisements for bargains or for other reasons, the caller would press the #2 key shown in FIG. 1 and hold it for a second. The service provider 21 would then connect the caller to the advertisement page. An automated voice prompter would then guide the caller through available advertisements. For example, for automotive advertisements, please press #1; for household item advertisements, please press #2; for ladies wear, please press #3; for gardening supplies, please press #4; for pet supplies, please press #5; etc.

For a discount on any of the featured advertisements, the caller would press the pound key at any time during or after the advertisement. Upon pressing the pound key, a text message which contains a barcode for the discount is sent to the caller's telephone.

The caller would press the star key to repeat any advertisement while browsing. Information that is related to the classified advertisement is imputed into the content database through any suitable method, including but not limited to a web-based application. The information can include marketing information or anything the advertiser wants the captive audience to hear.

The advertisers will specify to which telephone or mobile device the advertisement is to be (heard) sent.

The service provider will attach the advertisement to the call instead of a phone ring tone, and rotate advertisements to meet the wishes of the advertiser.

The type of database used includes, but is not limited to, DBZ, Informix IDS, Mimer, Java DB, My SQL, Sy Base, ASE, or I Data Store.

The content database is connected to a mobile delivery gateway untiling an application interface script. Examples of appropriate scripting includes Java, Active X, Pen, PHI′, C/CH, CR SMPP.

For each advertisement, the application script also manages and relay's additional critical information associated with each MT sent. The MT carries or contains the actual advertisement information.

The mobile delivery gateway is the platform that manages each session between all parties. This includes all the components necessary to manage each advertisement, delivery and script.

The mobile delivery gateway can include either a SMSC interface, or a MM's proxy-relay server, depending on the type of content and of the information and the corresponding message type which is sent based on the standard of SMS and MMS messaging.

Some of the differences between the present invention and previous methods are:

1) Advertising while on hold instead of silence;

2) Advertisements instead of voice mail instructions;

3) Advertisements before checking voice mail;

4) Just as dial (one) get voice mail, dial (two) to listen to continuous advertisements. Choose adds by pressing the pound key, receive confirmation text message to redeem for discounts. (Ad-check).

While the present invention has been described hereinabove with respect to several preferred embodiments for illustrative purposes only, it should be understood that the present invention encompasses and embraces all modifications, variations, and changes in the basic inventive concept.

Also, the variations and modifications are intended to be embraced within the scope of the present invention and the patent claims set forth hereinbelow.

Any and all such changes, modifications, variations and other uses and applications which do not depart from the spirit and scope of the present invention are therefore covered by and embraced within the patent claims set forth hereinbelow.

1. An advertisement method using a telephone system, comprising the steps of:
initiating a telephone call via a telephone device;
transmitting to the caller's telephone device one or more advertisements in lieu of placing the caller on hold to hear silence, in lieu of telephone ring back tones, before permitting voice mail instructions, and before permitting checking of voice mail;
choosing an advertisement which appeals to the caller by pressing a first predetermined key on the caller's telephone device; and
transmitting to the caller's telephone device a confirmation text message to permit the caller to redeem a discount relating to the advertisement chosen by the caller.

2. The advertisement method of claim 1, including the step of:
pressing a second predetermined key on the caller's telephone device to enable the caller to listen to continuous advertisements.

3. The advertisement method of claim 1, including the step of:
stopping an advertisement being listened to by the caller immediately if the intended party being called answers said initiated telephone call before said advertisement being listened to by the caller is completed.

4. The advertisement method of claim 2, including the step of:
stopping an advertisement being listened to by the caller immediately if the intended party being called answers said initiated telephone call before said advertisement being listened to by the caller is completed.

5. The advertisement method of claim 2, including the step of:
upon pressing said second predetermined key on the caller's telephone device to enable the caller to listen to continuous advertisements, connecting an automated voice prompter to the caller's telephone device to guide the caller though available advertisement categories which can be selected by the caller pressing an associated key on the caller's telephone device.

6. The advertisement method of claim 4, including the step of:
upon pressing said second predetermined key on the caller's telephone device to enable the caller to listen to continuous advertisements, connecting an automated voice prompter to the caller's telephone device to guide the caller though available advertisement categories which can be selected by the caller pressing an associated key on the caller's telephone device.

7. The advertisement method of claim 1, including the step of:
pressing a third predetermined key on the caller's telephone device to repeat an advertisement completely.

8. The advertisement method of claim 2, including the step of:
pressing a third predetermined key on the caller's telephone device to repeat an advertisement completely.

9. The advertisement method of claim 3, including the step of:
pressing a third predetermined key on the caller's telephone device to repeat an advertisement completely.

10. The advertisement method of claim 4, including the step of:
pressing a third predetermined key on the caller's telephone device to repeat an advertisement completely.

11. The advertisement method of claim 5, including the step of:
pressing a third predetermined key on the caller's telephone device to repeat an advertisement completely.

12. The advertisement method of claim 6, including the step of:
pressing a third predetermined key on the caller's telephone device to repeat an advertisement completely.

13. The advertisement method of claim 3, including the step of:
remaining on the line after the call is completed to enable the caller to hear the remainder of said stopped advertisement.

14. The advertisement method of claim 1, including the step of:
transmitting to the caller's telephone device a message stating “Please enjoy the message while your party is being reached.”

15. The advertisement method of claim 1 using a mobile telephone system, including the steps of:
sending said initiated telephone call to a cell tower;
relaying said initiated telephone call to a service provider;
checking a mobile identification number of the caller's telephone device; and
relaying the telephone call to a computer server which attaches said one or more advertisements for transmission to the caller's telephone device.

16. The advertisement method of claim 2 using a mobile telephone system, including the steps of:
sending said initiated telephone call to a cell tower;
relaying said initiated telephone call to a service provider;
checking a mobile identification number of the caller's telephone device; and
relaying the telephone call to a computer server which attaches said one or more advertisements for transmission to the caller's telephone device.

17. The advertisement method of claim 3 using a mobile telephone system, including the steps of:
sending said initiated telephone call to a cell tower;
relaying said initiated telephone call to a service provider;
checking a mobile identification number of the caller's telephone device; and
relaying the telephone call to a computer server which attaches said one or more advertisements for transmission to the caller's telephone device.

18. The advertisement method of claim 4 using a mobile telephone system, including the steps of:
sending said initiated telephone call to a cell tower;
relaying said initiated telephone call to a service provider;
checking a mobile identification number of the caller's telephone device; and
relaying the telephone call to a computer server which attaches said one or more advertisements for transmission to the caller's telephone device.

19. The advertisement method of claim 5 using a mobile telephone system, including the steps of:
sending said initiated telephone call to a cell tower;
relaying said initiated telephone call to a service provider;
checking a mobile identification number of the caller's telephone device; and
relaying the telephone call to a computer server which attaches said one or more advertisements for transmission to the caller's telephone device.

20. The advertisement method of claim 7 using a mobile telephone system, including the steps of:
sending said initiated telephone call to a cell tower;
relaying said initiated telephone call to a service provider;
checking a mobile identification number of the caller's telephone device; and
relaying the telephone call to a computer server which attaches said one or more advertisements for transmission to the caller's telephone device.
